(19) United States
(12) Patent Application Publication
(10) Pub. No.: US 2009/0288021 A1
(43) Pub. Date: Nov. 19, 2009

(54) SYSTEM AND METHOD TO SUPPORT DYNAMIC WIDGET DISTRIBUTION

(76) Inventors: Dimitry Ioffe, Los Angeles, CA (US); Jeff Lin, Playa Vista, CA (US); Brian Pettigrew, Hermosa Beach, CA (US)

Correspondence Address: PERKINS COIE LLP, P.O. BOX 1208, SEATTLE, WA, 98111-1208, US

(21) Appl. No.: 12/465,577

(22) Filed: May 13, 2009

Related U.S. Application Data
(60) Provisional application No. 61/052,875, filed on May 13, 2008.

(51) Int. Cl. G06F 3/048; G06F 3/01

(52) U.S. Cl. 715/760; 715/765

(57) ABSTRACT

A process is proposed that enables a widget vendor or aggregator to continuously present widgets via a widget network to a user who previously grabbed and embedded a first widget presented by the vendor or aggregator. The user may initiate the browsing of the widget network from a user placement where the first widget is embedded to choose and grab a second widget from the vendor. Here, the widgets in the widget network can be dynamically maintained and updated by the vendor and can be created at a time after the first widget was grabbed by the user. If the user grabs the first widget over the web and embeds the widget into his/her own placement, the user is presumably interested in the widget and it is likely that the user may also be interested in other widgets created by the same vendor or in the same category of interest.

### RELATED APPLICATIONS

This Application claims priority to U.S. Provisional Patent Application No. 61/052,875, filed May 13, 2008, and entitled “SYSTEM AND METHOD TO SUPPORT DYNAMIC WIDGET DISTRIBUTION” by Dimitry loffe, which is incorporated herein by reference.

### BACKGROUND

A widget is a portable software component, e.g., a branded content container, which can run practically anywhere on the Web (or in a desktop application) and can be virally distributed by users. As a viral tool, the widget allows users to grab the content of the widget and share the content with others by placing the widget on the users' own placement/website using HTML (HyperText Markup Language) or programming codes, e.g., APIs (Application Programming Interfaces). The widget enables the digital content to spread throughout the Web while allowing the vendor/creator of the widget to control content. More specifically, the vendor can modify the widget at any time no matter where the widget roams, wherein such modification includes but is not limited to, changing a video, adding a photo or changing the color of the widget.

A widget allows a vendor to build a syndicated content network by multiplicity. In ‘multiplicity’ the widget multiplies each time a user grabs and shares the widget somewhere else, providing the potential for exponential growth. The vendor may provide a ‘Launch Point’ for the widget on the vendor's website, in an ad banner, or via email marketing, and the user spreads the widget from the launch point by placing/embedding the widget in a user placement, such as the user's home page, website, profile, blog, or desktop. Each user may create an additional Launch Point for the widget to increase exposure to the public.

The power of the widget comes from two key aspects that are inherent to a branded widget:

Brand advocacy: when a user posts a vendor's widget to his/her website, that person is endorsing the vendor's product whether the user is consciously aware of that or not. An endorsement from a peer or trusted blog is far more powerful than a regular form of advertising.

Target audience: unlike premium priced behavioral advertising where the vendor pays to put ads in front of users whom the vendor thinks are part of the vendor's target audience, widgets find the vendor's target audience for the vendor. By using analytics, the vendor can locate “hot spots of activity” and gain insights about the people using the vendor's widgets.

Because of such power of the widget, it is imperative for the vendor to increase the exposure of as many of the vendor's widgets to a group of users as possible.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

A technique is proposed that enables a widget vendor or aggregator to continuously present the vendor's widgets via a widget network to a user who previously grabbed and embedded a first widget presented by the vendor or aggregator. The user may initiate the browsing of the widget network from a user placement where the first widget is embedded, to choose and grab a second widget from the vendor. Here, the widgets in the widget network can be dynamically maintained and updated by the vendor and can be created at a time after the first widget was grabbed by the user. If the user grabs the first widget over the web and embeds the widget into his/her own placement, the user is presumably interested in the widget and it is likely that the user may also be interested in other widgets created by the same vendor or in the same category of interest. For the user of the first widget, the proposed approach enables the user to be able to browse, pick, and grab other widgets that might be of interest to him/her from a single point (the first widget on the user placement) of his/her preference instead of searching through the Web exhaustively. For the vendor of the first widget, the proposed approach offers the vendor an opportunity to promote widgets to users of one of the vendor's “hit” widgets in order to capitalize on such popularity.

### BRIEF DESCRIPTION OF THE DRAWINGS

FIG. 1 depicts an example of a system diagram to support dynamic distribution of widgets.

FIG. 2 depicts a flowchart of an example of a process to support dynamic distribution of widgets from a vendor's perspective.

FIG. 3 depicts a flowchart of an example of a process to support dynamic distribution of widgets from a user's perspective.

FIGS. 4A-C depict an example of a widget embedded on a user placement, a widget browse component, and a widget embedded on a launch point and/or a widget network, respectively.

FIG. 5 depicts a computing system representative of the computing systems discussed herein.

FIG. 6 depicts a screenshot of an example of a widget on a user placement.

### DETAILED DESCRIPTION

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

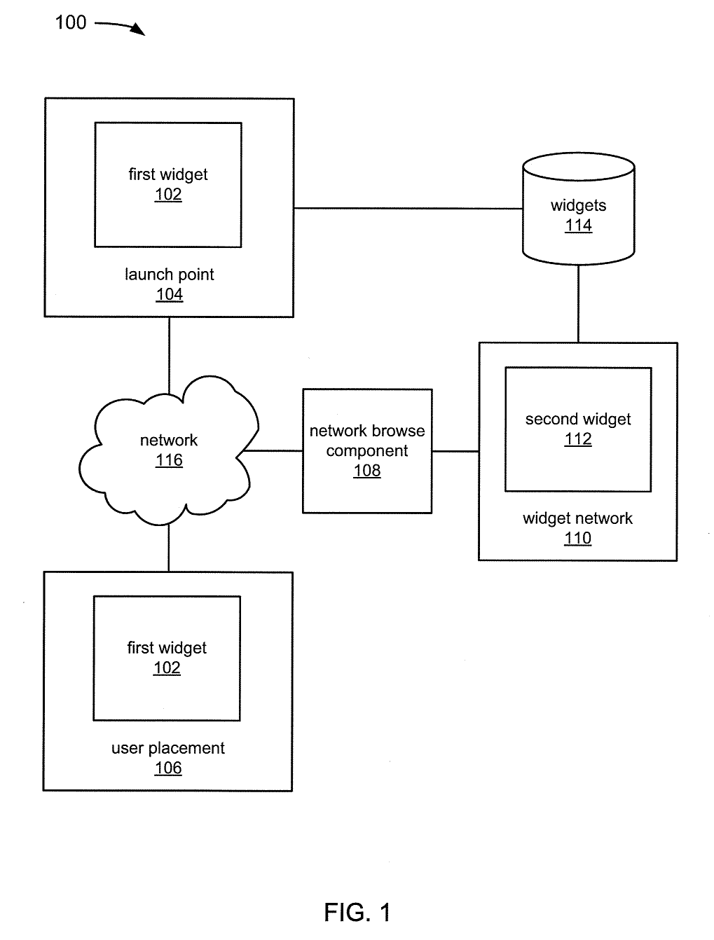

FIG. 1 depicts an example of a system diagram 100 to support dynamic distribution of widgets. In the example of FIG. 1, the system 100 includes a first widget 102, a launch point 104 for the first widget 102, a user placement 106 where the first widget 102 can be embedded, a network browse component 108 for a widget network 110 of one or more widgets, a second widget 112 in the widget network 110, a widgets repository 114, and a network 116.

In the example of FIG. 1, each of the components mentioned above can run on one or more hosting devices (hosts). Here, a host can be a computing device, a communication device, a storage device, a global positioning device (GPS), or any electronic device capable of running a software component. For non-limiting examples, a computing device can be but is not limited to, a laptop PC, a desktop PC, a tablet PC, an iPod, a PDA, or a server machine. A storage device can be but is not limited to a hard disk drive, a flash memory drive, or any portable storage device. A communication device can be but is not limited to a mobile phone.

In the example of FIG. 1, the first widget 102, the second widget 112, and the one or more widgets in the widget network 110 may each comprise one or more elements (not shown), wherein the one or more elements enable the user to perform functions on and/or interact with the widget. In some embodiments, each of the elements of the first widget 102, the second widget 112, and the one or more widgets in the widget network 110 can be created in Shockwave Flash (SWF) format. Here, SWF is an open file format for multimedia and especially vector graphics (e.g., geometrical primitives such as points, lines, curves, and shapes or polygon(s), which are based upon mathematical equations to represent images in computer graphics). Intended to be small enough for publication on the web, SWF files can contain animations or applets of varying degrees of interactivity and function. SWF is currently the dominant format for displaying animated vector graphics on the web, allowing audio, video and different forms of interaction with the user. Once created, SWF files can be played either as a browser plug-in, as a standalone player, or be encapsulated in a player.

In the example of FIG. 1, the launch point 104 presents/publishes the first widget 102 to a user and enables the user to locate the first widget 102 over the network 116. The launch point 104 can be but is not limited to, a website, an ad banner, or a marketing tool of a vendor of the first widget 102 who creates, owns, or distributes the first widget 102. In one embodiment, the launch point may be provided by an aggregator, who may create a network of widgets of the same category or with the same or similar interests. In addition to presenting the first widget 102 to the user, the launch point 104 also enables the user to “grab and share” the first widget 102 from the launch point 104 and place/embed/post the widget somewhere else. Here, “grab and share” function can be enabled by a Flash based platform that allows the duplication of content of the first widget 102 by creating HTML code and/or by using an API (application programming interface). The code that is duplicated usually displays a piece of information or content such as a video or photo gallery and may be self-contained, meaning the widget does not reference other elements from a website, or may include references to other elements such that a vendor/aggregator may remotely update the widget via the network 116. There are two ways that the user can duplicate the code of the first widget 102 and use the code on the user placement 106 (e.g. another website). One way is to copy the HTML embedded code and then paste that code into the HTML code of the user placement 106. That HTML will act as a pull mechanism to serve the content of the first widget 102 that the user wants to ‘grab’ and embed in its placement 106. The second way is to use one of the APIs for a website such as MySpace, Facebook or iGoogle, which automatically copies and pastes the HTML code for them and places the widget on the user placement 106 automatically. Either way, the actual content of the first widget 102 is always served from one place while the HTML may pull that content into the user placement 106. Here, the launch point 104 enables the user to copy the digital content of the first widget 102 and embed the content into the user placement 106 without handling the details of such content/code transfer. After being posted to the user placement 106, the content of the first widget 102 may still contain pointers to functions or files kept or maintained by the vendor to enable the vendor to continue to exercise control over the content of the first widget 102.

In the example of FIG. 1, the user placement 106 is the user's venue of choice to place/embed/post the first widget 102 grabbed from the launch point 104. Here, the user placement 106 can be but is not limited to, the user's home page, website, profile, blog, desktop, mobile phone operating system, or any other electronic form of the user's choice. In addition to posting the first widget 102 for the user, the user placement 106 also enables the user to utilize the embedded first widget as a “starting point” to gain access to other widgets over the network. In one embodiment, an element embedded in or associated with the first widget 102 or the user placement 106 as a plug-in may provide the user with the option to invoke browsing of the widget network 110 via the network browse component 108 from a single point each time the user accesses/visits the user placement 106 or the embedded first widget 102. For a non-limiting example, an element may be coded in SWF format.

In the example of FIG. 1, the network browse component 108, once invoked by the user via the embedded first widget 102 or the user placement 106, presents the widget network 110 comprised of one or more widgets to the user. Furthermore, the network browse component 108 enables the user to browse through the widget network to pick and choose a second widget 112 of interest to the user among those presented. The user may then grab the second widget 112 and share/place the second widget 112 somewhere else just as he/she grabbed the first widget 102. In one embodiment, the user may grab the second widget 112 and place the second widget 112 in the same user placement 106 as the first widget 102. In an alternative embodiment, the user may grab the second widget 112 and place the second widget 112 in a different placement of his/her preference that is not associated with the user placement 106 in which the first widget 102 is embedded.

In a non-limiting example, once invoked by the user, the widget network 110 may be presented in a browser, as a pop-up or modal window, or as part of the graphical user interface of the widget. In one embodiment, the network browse component 108 can be embedded in the user placement 102. A user may invoke the network browse component 108 from the user placement 106 or the launch point 104.

In the example of FIG. 1, the one or more widgets in the widget network 110 can be from the same vendor as the first widget 102 or belong to the same or a similar category or field of interest or relevance as the first widget 102. In the later case, the one or more widgets in the widget network can be compiled by a widget content aggregator, which is able to collect widgets created by multiple vendors.

In the example of FIG. 1, the widgets repository 114 stores and manages at least one or more of: the first widget 102, the second widget 112, the one or more widgets on the widget network 110, as well as other widgets and/or contents that are related to the creation of the widgets by the vendors. During the operation of the system 100, the widgets repository 114 stores updates for the launch point 104, the user placement 106, and the network browse component 108 with the respective widgets requested by these components.

As used in this paper, a repository can be implemented, for example, as software embodied in a physical computer-readable medium on a general- or specific-purpose machine, in firmware, in hardware, in a combination thereof, or in any applicable known or convenient device or system. The repositories described in this paper are intended, if applicable, to include any organization of data, including trees, tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 1, the network 116 enables the launch point 104, the user placement 106, the network browse component 108, and the widgets repository 114 to reach, communicate with, interact, and/or exchange information/data/files-with each other.

As used in this paper, a network, such as network 116, can include a networked system that includes several computer systems coupled together, such as the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed the network 104 broadly includes, as understood from relevant context, anything from a minimalist coupling of the components illustrated in the example of FIG. 1, to every component of the Internet and networks coupled to the Internet.

While the system 100 depicted in FIG. 1 is in operation, the first widget 102 is presented or sent to a user by a vendor or an aggregator or supplier of widgets, via the launch point 104, which the user is able to locate over the Web. Once the first widget 102 has been located by the user, the launch point 104 enables the user to grab the first widget 102 and place the first widget 102 on the user placement 106 of the user's choice. In a non-limiting example, the first widget may be part of the widget network 110. The first widget 102 is then embedded and “lives” on the user placement 106 while allowing the vendor to retain control over the content of the first widget 102. In addition, the first widget 102, and the user placement 106 allow the user to initiate an action to browse other widgets in the widget network 110 from a single point, wherein the widgets in the widget network 110 may be created by the same vendor or of the same or similar category or interest as the first widget 102. Once launched, the network browse component 108 presents the widget network 110 to the user and enables the user to browse through the one or more widgets in the widget network 110 and to pick and grab the second widget 112 of his/her interest similar to the user's action performed on the first widget 102. During the operation of the system 100, the widgets are provided and updated by the widgets repository 114 while the components in the system 100 interact and communicate with each other via the network 116.

In some embodiments, the system 100 depicted in FIG. 1 may further include a tracking system (not shown), which while in operation, collects and records information on operations performed on the first and the second widget by the user. Such information includes but is not limited to, which first and/or second widget the user grabs, where (which placement or venue) the widgets are embedded in, and how often the user visits these widgets. Such information would help the vendor to analyze the popularity of the vendor's widgets in order to develop and distribute widgets specifically targeted to the vendor's users.

In some embodiments, the one or more widgets in the widget network 110 can be created and/or published at a later time after the first widget 102 has been published and embedded in the user placement 106. In addition, the one or more widgets in the widget network 110 can be dynamically updated after the first widget has been published and embedded by the user. Such dynamic nature of the widget network provides the vendor or widget aggregator the ability to constantly present the user with the latest and/or the most interesting widgets that have been developed after the publication of the first widget 102 (e.g., based on the user's experiences with the first widget), each time the user visits his/her placement 106 and invokes browsing of the widget network 110. In this way the widget network 110 also offers the user the incentive to browse the widget network 110 regularly and frequently to see what widgets are coming up in his/her area of interest.

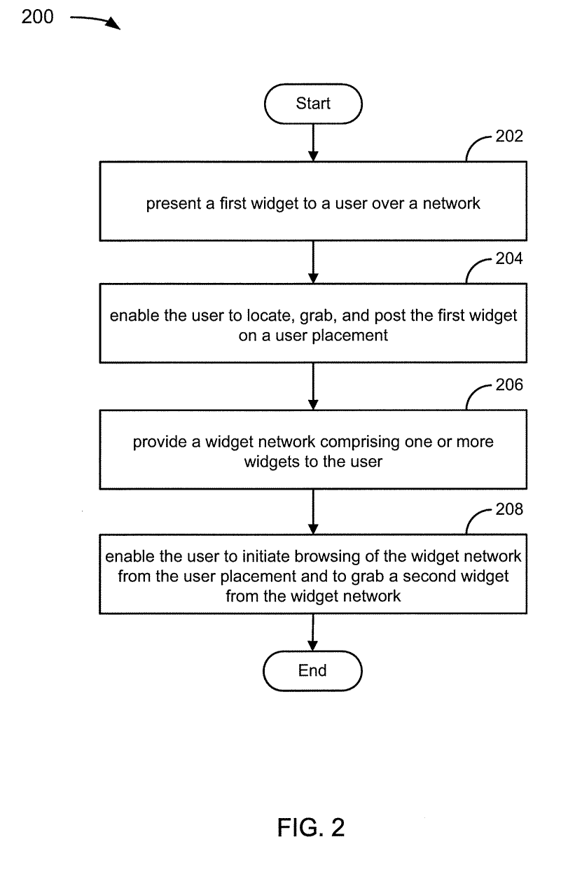

FIG. 2 depicts a flowchart of an example of a process to support dynamic distribution of widgets from a vendor's perspective. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

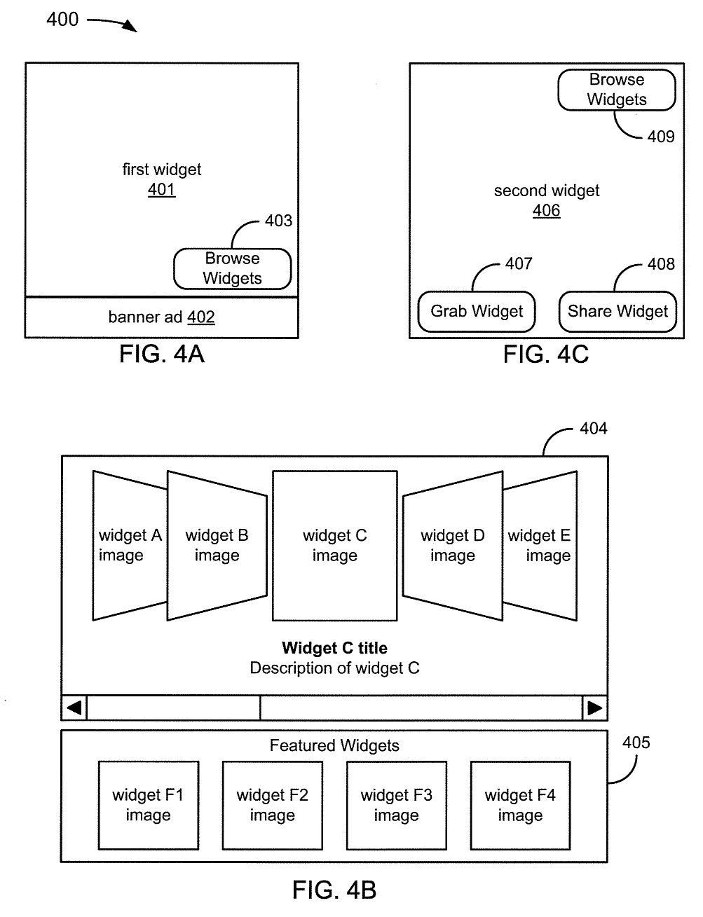

In the example of FIG. 2, the flowchart 200 starts at block 202 with presenting a first widget to a user over a network. The first widget can be presented using a display such as is displayed in, for example, FIG. 4B, discussed below.

The flowchart 200 continues to block 204 with enabling the user to locate, grab, and post the first widget on a user placement. The way in which the first widget is presented to the user, e.g., on a launch point of the vendor, enables the user to locate and grab the first widget and to post the first widget on a placement of the user's own choice.

The flowchart 200 continues to block 206 with providing a widget network comprising one or more widgets to the user. A widget network can be composed of one or more widgets that can be provided to the user. These one or more widgets may be developed by the same vendor and/or share the same characteristic or interest with the first widget.

The flowchart 200 ends at block 208 with enabling the user to initiate browsing of the widget network from the user placement and to grab a second widget from the widget network. The user placement and/or the first widget embedded in the user placement enables the user to invoke a network browse operation from them in order to browse the widget network and grab a second widget of his/her interest from the widget network. Having enabled the user to initiate browsing, the flowchart terminates.

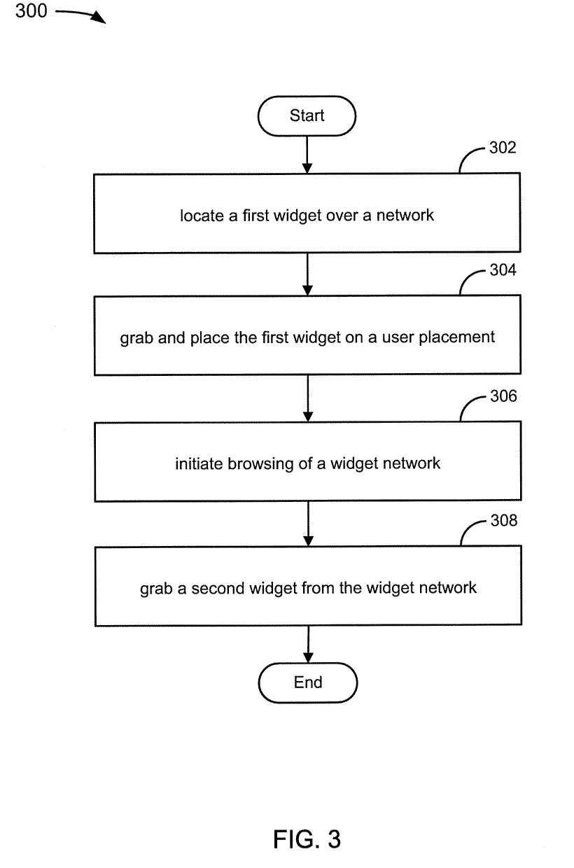

FIG. 3 depicts a flowchart of an example of a process to support dynamic distribution of widgets from a user's perspective. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302 with locating a first widget over a network. A user can locate a first widget posted by a vendor on one of the launch point over a network.

The flowchart 300 continues to block 304 with grabbing and placing the first widget on a user placement. The user can grab the first widget from the vendor's launch point and place or embed the first widget onto her own placement.

The flowchart 300 continues to block 306 with initiating browsing of a widget network. The user can initiate browsing of a widget network in search of one or more widgets for a user placement in which the first widget is embedded.

The flowchart 300 ends at block 308 with grabbing a second widget from the widget network. The user can find a second widget of his/her interest, and grab the second widget from the widget network to place on a placement of her preference. Having grabbed a second widget, the flowchart terminates.

FIG. 4A depicts an example of a first widget 401 embedded on a user placement (not shown). The first widget 401 may have been provided to the user in a similar way to the second widget 406, as described below. Alternatively, the first widget 401 may have been sent to the user by the vendor or aggregator. The first widget 401, as embedded on the user placement, may present a banner ad 402 to the user of the widget 401. Banner ad 402 may present other widgets from the same vendor or the same category to the user, wherein the banners can be rotated at a set time interval. Selecting the banner ad 402, for example by clicking on the banner ad 402, can link to a website where the widgets can be downloaded, or may link to a network browse component as described with reference to FIG. 4B. Banner ad 402 may show other widgets or any other form of advertising such as, for example, products or websites. Clicking on the banner ad 402 may result in the widget associated with the banner ad to be presented to the user, in a way similar to that as described with reference to FIG. 4C. In an alternative embodiment, when clicking on the banner ad, the user may be presented with the network browse component, with the widget associated with the banner ad highlighted.

In the example of FIG. 4A, a “Browse Widgets” button 403 enables a user to initiate a browsing action of a widget network by launching a network browsing component, such as that shown by the example in FIG. 4B. In a non-limiting example, the network browse component may be implemented on a web-browser. In another example, widgets related to the first widget 401 may be presented on the first widget 401, or may be presented in a pop-up or modal window upon a user request (e.g.: clicking “Browse Widgets” button 403). The related widgets may be from the same vendor as widget 401 or may be in the same category of interest as widget 401. In an alternative embodiment, the “Browse Widgets” button 403 may be replaced by any means allowing a user to access related widgets directly from the widget 401 or through the network browse component. For example, a representation of related widgets may be invoked by a mouseover event, when a cursor is moved over any area or a particular portion of the widget 401. Banner ad 402 and “Browse Widgets” button 403 may be integrated within the graphical user interface of the first widget 401 or be presented separately from the first widget 401 (for example as a pop-up window/menu).

FIG. 4B presents the list of widgets available in the widget network via a browse panel 404, which allows the user to browse through the widget network and to grab and “load” a second widget from the network to his/her placement of preference (not shown). In addition, a featured widgets panel 405 highlights a subset of the one or more widgets in the widget network and/or links to the vendor's web sites, which catches the attention of the user when the number of widgets in the widget network is large. A vendor may also be charged a premium for putting the vendor's widget(s) or website on the featured widgets panel 405. In one example, featured widgets panel 405 may show the most downloaded or highest rated widgets in the widget network from a vendor or from the same category. A tracking system, as described with reference to FIG. 1, may be used to collect information on operations performed on the first widget and the widgets in the widget network. The widgets presented in the featured widgets panel 405 may be chosen based on this information.

FIG. 4C depicts an example of a widget 406 embedded on a launch point and/or a widget network. Widget 406 may include “Grab Widget” button 407, “Share Widget” button 408 and “Browse Widgets” button 409. In a non-limiting example, a user may be presented with a second widget 406 after selecting a widget image from the browse panel 404 or the featured widgets panel 405. The first widget 401 may have been presented to the user in a similar way to the widget as depicted in FIG. 4C before the user embedded the first widget 401 on the launch point. In the example of FIG. 4C, the second widget 406 may be an image representation or a functional demo of the widget.

In the example of FIG. 4C, “Grab Widget” button 407 allows a user to grab the widget from the launch point and/or widget network and embed the widget in a user placement, as described with reference to FIG. 1 above. “Share Widget” button 408 may allow a user to share second widget 406 with other users. In a non-limiting example, selecting “Share Widget” button 408 may result in an email, SMS, or other form of communication, containing a link to the widget, to be sent to selected users. Alternatively, the file itself may be sent to the users, for example via email attachment, or via direct file transfer over TCP/IP (Transmission Control Protocol I Internet Protocol) or FTP (File Transfer Protocol) based networks, or cellular networks such as GSM (Global System for Mobile communications), or UMTS (Universal Mobile Telecommunications System). “Share Widget” button 408 may also be present on the first widget 401, or on the second widget 406, when the second widget 406 is embedded in the user placement. In a non-limiting example, the buttons may be replaced by hyperlinks, or a prompt may appear upon selection of a button.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. Also, consider integrated circuits or interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD (Digital Versatile Disc/Digital Video Disc), CD-ROMs (Compact Disc-Read Only Memory), micro drive, and magneto-optical disks, ROMs (Read Only Memory), RAMs (Random Access Memory), EPROMs (Erasable Programmable Read-Only Memory), EEPROMs (Electronically Erasable Programmable Read-Only Memory), DRAMs (Digital Random Access Memory), VRAMs (Video Read Only Memory), flash memory devices, magnetic or optical cards, nanosystems (including molecular memory ICs (integrated circuits)), or any type of media or device suitable for storing instructions and/or data. Stored on any one of the computer readable medium (media), software can control both the hardware of the general purpose/specialized computer or microprocessor, and for enabling the computer or microprocessor to interact with a human viewer or other mechanism operating in accordance with the teachings discussed herein. Such software may include, but is not limited to, device drivers, operating systems, execution environments/containers, and applications.

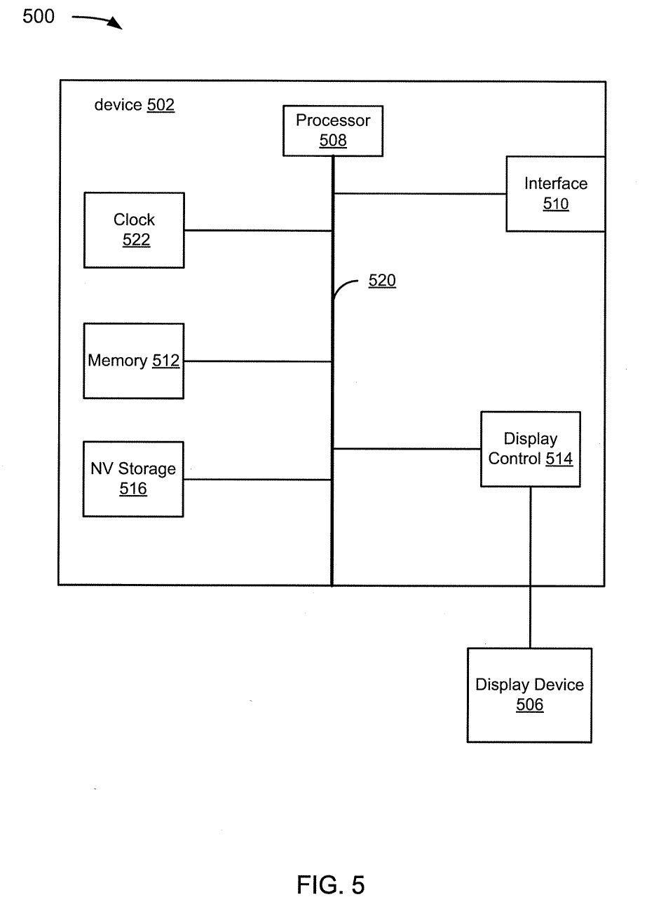

FIG. 5 depicts an example of a system 500 suitable for personalized screening of content. The system 500 may be a conventional computer system that can be used as a client computer system, such as a wireless client or a workstation, or a server computer system. The system 500 includes a device 502, I/O devices 504, and a display device 506. The device 502 includes a processor 508, a communications interface 510, memory 512, display controller 514, non-volatile storage 516, I/O controller 518, and clock 522. The device 502 may be coupled to or include the I/O devices 504 and the display device 506.

The device 502 interfaces to external systems through the communications interface 510, which may include a modem or network interface. It will be appreciated that the communications interface 510 can be considered to be part of the system 500 or a part of the device 502. The communications interface 510 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 508 may be, for example, a conventional microprocessor such as an Intel Pentium microprocessor or Motorola power PC microprocessor. The memory 512 is coupled to the processor 508 by a bus 520. The memory 512 can be Dynamic Random Access Memory (DRAM) and can also include Static RAM (SRAM). The bus 520 couples the processor 508 to the memory 512, also to the non-volatile storage 516, to the display controller 514, and to the I/O controller 518.

The I/O devices 504 can include a keyboard, disk drives, printers, a scanner, and other input and output devices, including a mouse or other pointing device. The display controller 514 may control in the conventional manner a display on the display device 506, which can be, for example, a cathode ray tube (CRT) or liquid crystal display (LCD). The display controller 514 and the I/O controller 518 can be implemented with conventional well known technology.

The non-volatile storage 516 is often a magnetic hard disk, flash memory, an optical disk, or another form of storage for large amounts of data. Some of this data is often written, by a direct memory access process, into memory 512 during execution of software in the device 502. One of skill in the art will immediately recognize that the terms “machine-readable medium” or “computer-readable medium” includes any type of storage device that is accessible by the processor 508.

Clock 522 can be any kind of oscillating circuit creating an electrical signal with a precise frequency. In a non-limiting example, clock 522 could be a crystal oscillator using the mechanical resonance of vibrating crystal to generate the electrical signal.

The system 500 is one example of many possible computer systems which have different architectures. For example, personal computers based on an Intel microprocessor often have multiple buses, one of which can be an I/O bus for the peripherals and one that directly connects the processor 508 and the memory 512 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 512 for execution by the processor 508. A Web TV system, which is known in the art, is also considered to be a computer system, but it may lack some of the features shown in FIG. 5, such as certain input or output devices. A typical computer system will usually include at least a processor, memory, and a bus coupling the memory to the processor.

In addition, the system 500 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 516 and causes the processor 508 to execute the various acts required by the operating system to input and output data and to store data in memory, including storing files on the non-volatile storage 516.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

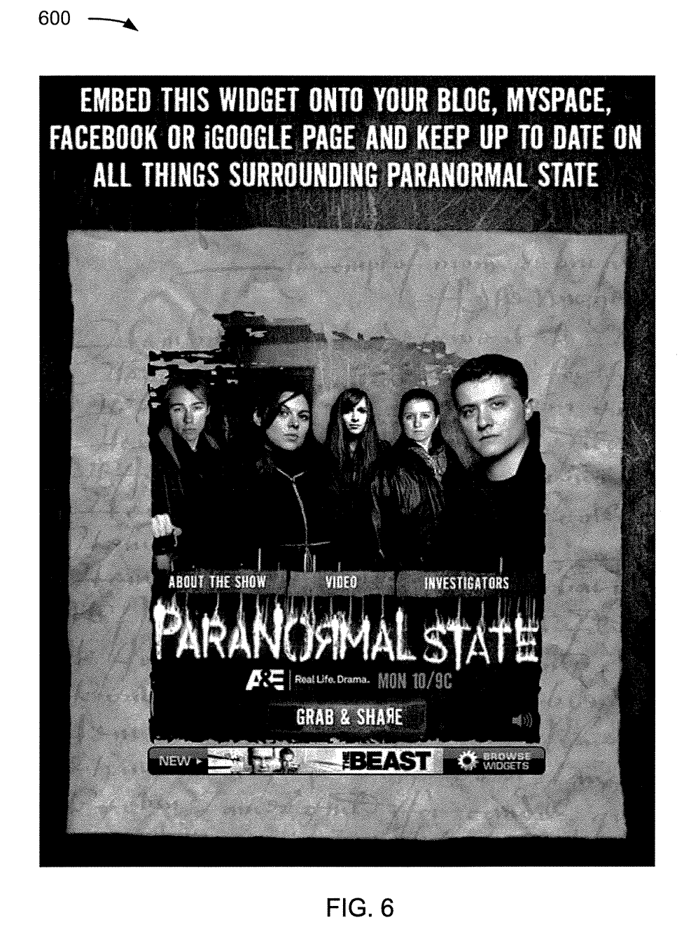

FIG. 6 depicts a screenshot of an example of a widget on a user placement. The widget provides content related to the television show “Paranormal State.”

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system for facilitating widget distribution, the system comprising:
a launch point including a first widget, said launch point configured to allow said first widget to be placed on a user placement; and
a widget network including one or more widgets;
wherein the first widget is configured to provide access from the user placement to at least one of the widgets.

2. The system of claim 1, wherein the one or more widgets include a second widget, wherein the second widget is placed on the user placement.

3. The system of claim 1, wherein the one or more widgets include a second widget, wherein the second widget is placed on a second user placement.

4. The system of claim 1, wherein the first widget is part of the widget network.

5. The system of claim 1 further including a network browse component embedded in a machine readable medium, wherein the network browse component presents the one or more widgets to a user of the first widget.

6. The system of claim 5, wherein the network browse component dynamically updates the one or more widgets in the widget network after the first widget has been embedded in the user placement.

7. The system of claim 5, wherein the user placement enables a user to invoke the network browse component from a plug-in on the first widget.

8. The system of claim 5, wherein the one or more widgets are created by a same vendor or of same or similar category or field of interest or relevance.

9. The system of claim 1, wherein at least some of the one or more widgets are published at a time after the first widget has been embedded in the user placement.

10. The system of claim 1 further comprising a widgets repository operable to store and manage the first widget and/or the one or more widgets.

11. The system of claim 10, wherein the launch point and/or the network browse component obtains the first widget and the one or more widgets from the widgets repository, respectively.

12. The system of claim 1, wherein the launch point includes a presentation system embedded in a machine readable medium, wherein the presentation system displays a web page, an ad banner, or a marketing tool presenting the first widget to a user of the launch point.

13. The system of claim 1, wherein the user placement includes a graphical user interface embedded in a machine readable medium, wherein the graphical user interface includes a home page, a website, a profile, a blog, a desktop, or a mobile phone interface.

14. The system of claim 1 further comprising a network, wherein the user placement communicates with the launch point and/or the widget network through the network, wherein the network is one of: internet, intranet, wide area network (WAN), local area network (LAN), wireless network, Bluetooth, WiFi, WiMAX, mobile communication network, GSM, UMTS, and any TCP/IP based network.

15. The system of claim 1 further comprising a featured widgets panel embedded in a machine readable medium, which while in operation, presents a subset of the one or more widgets.

16. The system of claim 1 further comprising a tracking system embedded in a machine readable medium, which while in operation, collects and records information on operations performed on the first and the second widget by the user.

17. A system for facilitating widget distribution, the system comprising:
means for enabling a first widget to be placed on a user placement;
means for providing a widget network including one or more widgets, wherein the means for providing the widget network is configured to dynamically update the one or more widgets after the first widget has been placed on the user placement; and
means for presenting the one or more widgets to a user;
wherein, in operation, the first widget enables the one or more widgets to be accessed from the user placement; and
wherein the means for presenting the one or more widgets enables the user to place at least one of the widgets on the user placement and/or a second user placement.

18. A method for facilitating distribution of widgets, the method comprising:
placing a first widget on a user placement;
accessing a widget network including one or more widgets, wherein the first widget is configured to enable a user of the first widget to:
browse the one or more widgets including a second widget;
install the second widget on a user placement and/or a second user placement; and
placing the second widget on the user placement and/or a second user placement.

19. The method of claim 18, wherein at least some of the widgets are created at a time after the first widget has been placed on the user placement.

20. The method of claim 18, wherein the user placement is a home page, a website, a profile, a blog, a desktop, or a mobile phone interface.

21. A method for facilitating distribution of widgets, the method comprising:
enabling a first widget to be placed on a user placement;
providing access to a widget network from the user placement when said first widget is placed on said user placement, wherein the widget network includes one or more widgets; and
enabling at least one of the widgets to be placed on the user placement and a second user placement.

22. The method of claim 21, wherein elements of the first widget and/or the one or more widgets are created in Shockwave Flash (SWF) format.

23. The method of claim 21 further including collecting and recording information on operations performed on the first widget and the second widget by a user of the first widget.

24. The method of claim 23 further comprising highlighting a subset of the widgets when the widget network is accessed by the user, wherein the highlighted subset is a function of the information.

25. The method of claim 21, wherein the user placement is a home page, a website, a profile, a blog, a desktop, or a mobile phone interface.

26. The method of claim 21 further comprising creating and/or publishing and/or updating the one or more widgets at a time after the first widget has been placed on the user placement.
